(19) United States
(12) Patent Application Publication
(10) Pub. No.: US 2026/0208051 A1
(43) Pub. Date: Jul. 23, 2026

(54) GAME INTERACTION METHOD AND APPARATUS, STORAGE MEDIUM AND ELECTRONIC DEVICE

(71) Applicant: NETEASE (HANGZHOU) NETWORK CO., LTD., Hangzhou, Zhejiang (CN)

(72) Inventor: Weinan LI, Hangzhou, Zhejiang (CN)

(73) Assignee: NETEASE (HANGZHOU) NETWORK CO., LTD., Hangzhou, Zhejiang (CN)

(21) Appl. No.: 19/136,864

(22) PCT Filed: May 18, 2023
(86) PCT No.: PCT/CN2023/095135

§ 371 Date: Jun. 7, 2025

(30) Foreign Application Priority Data
Dec. 9, 2022 (CN) 202211585552.4

(51) Int. Cl. A63F 13/69; A63F 13/533; A63F 13/537; A63F 13/837

(52) U.S. Cl. CPC A63F 13/69; A63F 13/533; A63F 13/537; A63F 13/837; A63F 2300/638

(57) ABSTRACT

A game interaction method and apparatus, a storage medium and an electronic device. The method includes: in response to a virtual character being eliminated in a first game scene, controlling at least some of virtual items to be in a lost state; and in response to a retrieval instruction for the lost-state items, loading a second game scene, and configuring the lost-state items in the second game scene, so that the virtual character can retrieve the lost-state items in the second game scene, wherein the second game scene is the current out-of-game scene of the virtual character.

### CROSS-REFERENCE TO RELATED APPLICATIONS

The present disclosure is a U.S. National Phase Application of International Application No. PCT/CN2023/095135, filed on May 18, 2023, which is based on and claims the priority to the Chinese Patent Application No. 202211585552.4, entitled “Game interaction method, apparatus, storage medium and electronic device”, filed on Dec. 9, 2022, the entire contents of both of which are incorporated herein by reference for all purposes.

### TECHNICAL FIELD

The present disclosure relates to the field of game technology, and in particular to a game interaction method, apparatus, storage medium and electronic device.

### BACKGROUND

During the game process of shooting games, some virtual items are placed in different corners of a virtual scene, and then players pick them up in the virtual scene, and they can also capture the virtual items of other players from other players through competitions or other manners. However, after the player fails in the game and is eliminated, all the virtual items he obtained will be lost and cannot be taken away from the current game, which will result in poor game experience for the player.

### SUMMARY

The present disclosure provides a game interaction method, apparatus, storage medium and electronic device.

In the first aspect, the present disclosure provides a game interaction method, a graphical user interface is provided through a first terminal, a content displayed by the graphical user interface includes a first game scene, the first game scene includes a first virtual character controlled by the first terminal, the first virtual character carries virtual items, and the first game scene is a current in-game scene of the first virtual character, the method includes:
controlling to configure at least part of the virtual items as lost-state items, in response to elimination of the first virtual character in the first game scene;
loading a second game scene in the graphical user interface in response to a retrieval instruction for the lost-state items, and configuring the lost-state items into the second game scene, such that the first virtual character corresponding to the first terminal is able to retrieve the lost-state items by completing a specified game action in the second game scene, wherein the second game scene is a current out-of-game scene of the first virtual character.

In a second aspect, the present disclosure provides a game interaction method, a graphical user interface is provided through a second terminal, a content displayed by the graphical user interface includes a first game scene, the first game scene includes a first virtual character carrying virtual items and a second virtual character controlled by the second terminal, the method includes:
displaying lost-state items corresponding to the first virtual character in the first game scene, in response to elimination of the first virtual character from the first game scene, wherein the lost-state items are at least part of the virtual items;
configuring at least part of the lost-state items as an unpickable state within a specified time in the first game scene, in response to an item retrieval event for the lost-state items in the second game scene;
configuring a pick-up state of unretrieved lost-state items in the first game scene from an unpickable state to a pickable state, in response to expiration of the specified time and/or the at least part of the lost-state items not being retrieved.

In a third aspect, the present disclosure provides a game interaction apparatus, which provides a game interaction apparatus, a graphical user interface is provided through a first terminal, a content displayed by the graphical user interface includes a first game scene, the first game scene includes a first virtual character controlled by the first terminal, the first virtual character carries virtual items, and the first game scene is a current in-game scene of the first virtual character, the apparatus includes:
a first response module, configured to control to configure at least part of the virtual items as lost-state items, in response to elimination of the first virtual character in the first game scene;
a second response module, configured to load a second game scene in the graphical user interface in response to a retrieval instruction for the lost-state items, and configure the lost-state items into the second game scene, such that the first virtual character corresponding to the first terminal is able to retrieve the lost-state items by completing a specified game action in the second game scene, wherein the second game scene is a current out-of-game scene of the first virtual character.

In a fourth aspect, the present disclosure provides a game interaction apparatus, a graphical user interface is provided through a second terminal, a content displayed by the graphical user interface includes a first game scene, the first game scene includes a first virtual character carrying virtual items and a second virtual character controlled by the second terminal, the apparatus includes:
a third response module, configured to display lost-state items corresponding to the first virtual character in the first game scene, in response to elimination of the first virtual character from the first game scene, wherein the lost-state items are at least part of the virtual items;
a fourth response module, configured to configure at least part of the lost-state items as an unpickable state within a specified time in the first game scene, in response to an item retrieval event for the lost-state items in the second game scene;
a fifth response module, configured to configure a pick-up state of unretrieved lost-state items in the first game scene from the unpickable state to a pickable state, in response to expiration of the specified time and/or the at least part of the lost-state items not being retrieved.

In a fifth aspect, the present disclosure provides a non-transitory computer-readable storage medium, which stores a computer program, and the computer program implements the above methods when executed by a processor.

In a sixth aspect, the present disclosure provides an electronic device, including: a processor; and a memory for storing executable instructions of the processor; wherein the processor is configured to execute the above methods by executing the executable instructions.

It is to be understood that the foregoing general description and the following detailed description are exemplary and explanatory only and are not restrictive of the present disclosure.

### BRIEF DESCRIPTION OF THE DRAWINGS

The drawings herein are incorporated into the specification and constitute a part of the specification, showing embodiments consistent with the present disclosure, and are used to explain the principles of the present disclosure together with the specification. The drawings described below are only some embodiments of the present disclosure, and for ordinary technicians in this field, other drawings can be obtained based on these drawings without creative work.

FIG. 1 shows a flow chart of one of the game interaction methods in at least one embodiment of the present disclosure;

FIG. 2 shows a schematic diagram of an item capture control in one of the game interaction methods in at least one embodiment of the present disclosure;

FIG. 3 shows a schematic diagram of another item capture control in one of the game interaction methods in at least one embodiment of the present disclosure;

FIG. 4 shows a graphical user interface diagram in a second game scene in one of the game interaction methods in at least one embodiment of the present disclosure;

FIG. 5 shows a flow chart of one of the game interaction methods in at least one embodiment of the present disclosure;

FIG. 6 shows a flow chart of one of the game interaction methods in at least one embodiment of the present disclosure;

FIG. 7 shows a flow chart of one of the game interaction methods in at least one embodiment of the present disclosure;

FIG. 8 shows a flow chart of one of the game interaction methods in at least one embodiment of the present disclosure;

FIG. 9 shows a flow chart of one of the game interaction methods in at least one embodiment of the present disclosure;

FIG. 10 shows a flow chart of another game interaction method in at least one embodiment of the present disclosure;

FIG. 11 shows a flow chart of one of the game interaction methods in at least one embodiment of the present disclosure;

FIG. 12 shows a flow chart of one of the game interaction methods in at least one embodiment of the present disclosure;

FIG. 13 shows a schematic diagram of the structure of one of the game interaction apparatuses in at least one embodiment of the present disclosure;

FIG. 14 shows a schematic diagram of the structure of another game interaction apparatus in at least one embodiment of the present disclosure;

FIG .15 shows a schematic diagram of the structure of one of the electronic devices in at least one embodiment of the present disclosure.

### DETAILED DESCRIPTION

The example embodiments will now be described more fully with reference to the accompanying drawings. However, the example embodiments can be implemented in a variety of forms and should not be construed as being limited to the examples set forth herein; rather, these embodiments are provided so that the present disclosure will be more comprehensive and complete and the concepts of the example embodiments will be fully conveyed to those skilled in the art. The described features, structures or characteristics may be combined in one or more embodiments in any suitable manner. In the following description, many specific details are provided to provide a full understanding of the embodiments of the present disclosure. However, those skilled in the art will appreciate that the technical solutions of the present disclosure may be practiced while omitting one or more of the specific details, or other methods, components, apparatuses, steps, etc. may be adopted. In other cases, known technical solutions are not shown or described in detail to avoid obscuring various aspects of the present disclosure.

In addition, the accompanying drawings are only schematic diagrams of the present disclosure and are not necessarily drawn to scale. The same reference numerals in the drawings represent the same or similar parts, and thus their repeated descriptions will be omitted. Some of the block diagrams shown in the accompanying drawings are functional entities and do not necessarily correspond to physically or logically independent entities. These functional entities can be implemented in software form, or in one or more hardware modules or integrated circuits, or in different networks and/or processor apparatuses and/or microcontroller apparatuses.

The flowcharts shown in the accompanying drawings are only exemplary and do not necessarily include all the steps. For example, some steps can also be decomposed, while some steps can be merged or partially merged, so the actual execution order may change according to the actual situation.

In the related art, in the Tarkov-type shooting game, some virtual items are placed in different corners of the virtual scene, and then the players pick them up in the virtual scene, and they can also capture the virtual items of other players from other players through competitions or other manners. However, in the Tarkov-type shooting game, after the player fails in the game and is eliminated, all the virtual items he obtained will be lost and cannot be taken away from the current game, which will result in poor game experience for the player.

In view of the above problems, embodiments of the present disclosure provide a game interaction method, which provides a virtual level to the player after the player fails in the game, and the player can recapture the virtual resources lost in the game by passing levels in the virtual level, thereby improving game experience of the player and richness of game interaction.

The following is a brief explanation of some of the terms involved in the embodiments of the present disclosure.

### Virtual Scene

The virtual scene is a virtual scene displayed (or provided) when the application runs on a terminal or server. Optionally, the virtual scene is a simulation environment of the real world, or a semi-simulation and semi-fictitious virtual environment, or a purely fictitious virtual environment. The virtual scene is any one of a two-dimensional virtual scene and a three-dimensional virtual scene. The virtual environment can be the sky, land, ocean, etc., wherein the land includes environmental elements such as deserts and cities. The virtual scene is a scene where the user controls virtual objects to complete the game logic. For example, in sandbox 3D shooting games, the virtual scene is a 3D game world for players to control virtual objects to fight. Instances of virtual scenes may include: at least one element of mountains, plains, rivers, lakes, oceans, deserts, skies, plants, buildings, and vehicles. For example, in 2D card games, the virtual scene is a scene for displaying released cards or displaying virtual objects corresponding to cards. Instances of virtual scenes may include: arena, battle field, or other “field” elements or other elements that can display the battle state of cards. For 2D or 3D multiplayer online tactical competitive games, the virtual scene is a 2D or 3D terrain scene for virtual objects to fight. Instances of virtual scenes may include: canyon-style mountains, routes, rivers, classrooms, tables and chairs, platforms and other elements.

### Virtual Resources

The virtual resources are virtual props (such as guns, protective gear, items, building items, etc.), virtual assets (such as gold coins, points, etc.) or virtual objects (such as monsters, buildings, etc.) obtained through complete feature game tasks in or outside the game, which can help virtual objects better complete the game objectives. In an optional implementation, for example, in shooting games, virtual resources can be guns, ammunition, protective gear, gun accessories, treatment items, detachable houses, etc.; in MOBA games, virtual resources can refer to monster virtual objects with different attributes, etc.

### Virtual Character

The virtual character refers to a dynamic character that can be controlled in a virtual scene. Optionally, the dynamic character can be a virtual person, a virtual animal, an anime character, etc. The virtual character is a character controlled by the player through an input device, or an artificial intelligence (AI) trained for battle in a virtual environment, or a non-player character (NPC) set for battle in a virtual scene. Optionally, the virtual character is a virtual person that competes in a virtual scene. Optionally, the number of virtual characters in the virtual scene battle is preset, or dynamically determined according to the number of clients joining the battle, which is not limited in the embodiments of the present disclosure. In one possible implementation, the user can control the virtual character to move in the virtual scene, for example, control the virtual character to run, jump, crawl, etc., and can also control the virtual character to fight with other virtual characters using skills, virtual props, etc. provided by the application.

### Game Scene

The game scene refers to the scene in which the virtual character performs game actions in the virtual scene, such as passing levels, picking up items, competing with NPCs or other virtual characters, etc.

The following is a brief introduction to the application environment of the game interaction method provided in the embodiments of the present disclosure.

The game interaction method provided in the embodiments of the present disclosure is applied to a terminal device. The terminal device can be a server or a user terminal. The terminal device can be a server, a computer device, a personal laptop, or other wearable devices, etc., which are not specifically limited here. The terminal device provides a graphical user interface when running. The graphical user interface displays part of the virtual scenes of the game, as well as controls, components, icons, etc. for information interaction with players. There are a plurality of terminal devices, and different players control different virtual characters on different terminal devices to interact in the game scene. For example, the first player controls the first virtual character through the first terminal, and the second player controls the second virtual character through the second terminal. The first virtual character and the second virtual character interact engage in game interaction within the first game scene. The first terminal provides a graphical user interface when running. The content displayed by the graphical user interface includes the first game scene. The first game scene includes the first virtual character controlled by the first terminal, and the first virtual character carries virtual items.

The embodiments of the present disclosure involve at least two game scenes. The first game scene is the current in-game scene of the first virtual character. The first virtual character competes in the game, passes the level, etc. in the first game scene. The first game scene can be understood as the initial game of the player's games. The second game scene is a supplementary game after the player fails in the game or is eliminated. Game levels such as resource picking scenes and passing the level can be set, so that the virtual character who fails in the game in the first game scene can continue to play the game in the second game scene, so as to improve the richness and fun of the game interaction.

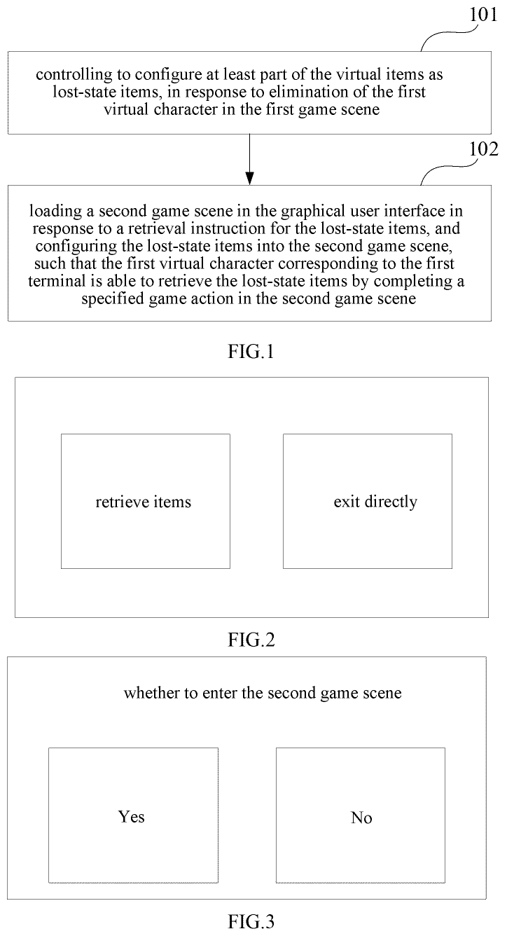

The following uses the above-mentioned terminal device as the execution subject, and applies the game interaction method to the terminal device to interact with the current game as an example. Referring to FIG. 1, the game interaction method provided by the embodiment of the present disclosure includes the following steps 101-102.
Step 101, in response to elimination of the first virtual character in the first game scene, it is controlled to configure at least part of the virtual items as lost-state items.

The lost-state items refer to the items that are automatically retrieved by the system due to the elimination of the first virtual character in the first game scene, or the virtual items that are dropped when the first virtual character is attacked by other virtual characters in the first game scene. The lost-state items can be items carried by the first virtual character, or they can be stored in a safe or other warehouse with a security level by the first virtual character. The embodiment of the present disclosure does not make any limitation, and it can be specifically set or configured according to actual conditions.
Step 102, in response to a retrieval instruction for the lost-state items, a second game scene is loaded in the graphical user interface and the lost-state items are configured into the second game scene, such that the first virtual character corresponding to the first terminal is able to retrieve the lost-state items by completing a specified game action in the second game scene.

The second game scene is a current out-of-game scene of the first virtual character, that is, a further supplement to the game in the first game scene. The determination manners of the retrieval instruction may include but is not limited to the following two manners: the first manner, an instruction automatically responding and automatically generated when the first virtual character is eliminated; the second manner, the instruction generated by the player through touch operation on the first terminal, that is, the instruction is not automatically generated, but the instruction is selected by the player to enter the second game scene. After responding to the retrieval instruction, the first terminal switches the first game scene in the graphical user interface to the second game scene, and displays the above part of the lost-state items in the second game scene. The player can perform the corresponding game action through the game operation on the first terminal, for example, controlling the first virtual character to engage in activities such as picking up, passing levels, and competitive scoring, so as to retrieve in the second game scene again the lost-state items lost in the first game scene.

The game interaction method provided by the embodiment of the present disclosure controls to configure at least part of the virtual items as lost-state items, in response to elimination of the first virtual character in the first game scene, loads a second game scene in the graphical user interface in response to a retrieval instruction for the lost-state items, and configures the lost-state items into the second game scene, such that the first virtual character corresponding to the first terminal is able to retrieve the lost-state items by completing a specified game action in the second game scene. In this way, after the first virtual character is eliminated, the lost-state items lost by the first virtual character in the first game scene are configured into the second game scene, and the first virtual character can retrieve the items lost in the first game scene again through the set game action in the second game scene, which increases the richness and diversity of game interaction, thereby solving the technical problem that the game interaction form of current shooting games is relatively single, and achieves the technical effect of improving the richness of game interaction and improving the game experience of players.

In at least one embodiment of the present disclosure, the virtual items include a plurality of security levels, step 101 of controlling to configure at least part of the virtual items as lost-state items in response to elimination of the first virtual character in the first game scene includes the following step:
controlling to configure items in the virtual items with a security level less than a preset security level as lost-state items, in response to the elimination of the first virtual character in the first game scene.

The security level is used to characterize the difficulty of capturing the virtual items. The higher the security level is, the less likely the virtual item is to be lost or captured. For example, the security level includes three levels from strong to weak: the first level is safes, the second level is warehouses, and the third level is items carried on one's body. If the preset security level is the second level, the virtual items carried by the first virtual character are configured as lost-state items after the first virtual character is eliminated, and the first virtual character needs to retrieve them by completing the set game action in the second game scene. The virtual items in the first and second levels are not affected by the elimination. This is only an example. The preset security level and the number of set security levels can be set according to actual conditions, and the embodiment of the present disclosure does not make any restrictions.

The embodiment of the present disclosure sets a security level, and configures the items with a security level less than the preset security level as lost-state items after the first virtual character is eliminated in the first game scene, thereby protecting items of the first virtual character with a security level greater than or equal to the preset security level from being not affected by elimination of the current game, and can continue to be used in the next game. The items of the virtual character are safer, which can further improve the interactive experience of players in game interaction.

In at least one embodiment of the present disclosure, the above step 102 of loading a second game scene in the graphical user interface in response to a retrieval instruction for the lost-state items includes the following step A:
step A, displaying an item capture control in the graphical user interface.

The item capture control is used to provide players with a choice of whether to enter the second game scene to retrieve items. For example, please refer to FIG. 2, the item capture control includes two sub-controls of “retrieve items” and “exit directly”. Players enter the second game scene by clicking “confirm operation” to pass levels and retrieve items, or click “exit directly” to exit the current game and enter the game lobby. Or, refer to FIG. 3, the item capture control includes a display component of “whether to enter the second game scene”, and two sub-controls of “Yes” and “No”. Players enter the second game scene by clicking “Yes” to pass levels and retrieve items, or click “No” to exit the current game and enter the game lobby. The forms of the item capture control are not exhaustive here, and can be flexibly configured according to actual needs.

For the above step A, there may be two situations when the player operates the item capture control.

The first situation: the second game scene is loaded in the graphical user interface, in response to a confirmation operation for the item capture control, wherein an instruction corresponding to the confirmation operation is the retrieval instruction for the lost-state items.

For example, a player clicks the “retrieve items” sub-control or the “Yes” sub-control in the above item capture control, after the first terminal responds to the confirmation operation, it will count the virtual resources lost by the player's current account in the first game scene, and distribute the virtual resources to the second game scene according to the set configuration manner, and display the second game scene in the graphical user interface at the same time, so that the player can retrieve the lost virtual items through game actions such as passing levels and picking up in the second game scene. It should be explained that, the second game scene may include the virtual items lost by the player account in the first game scene, and may also include the virtual items lost by other players in the first game scene, as well as some virtual items randomly configured by the system, etc., which are not exhaustive and specifically limited here.

The second situation: the first virtual character is controlled to exit the first game scene, and it is controlled to reclaim the virtual items carried by the first virtual character in the first game scene, in response to an abandonment operation for the item capture control.

For example, the player exits the current game by clicking the above “exit directly” or “No” sub-control, enters the game lobby, and does not continue the item retrieval action.

In the embodiment of the present disclosure, after the first virtual character is eliminated, an item capture control is directly displayed in the graphical user interface, so that the player can choose whether to enter the second game scene to retrieve the lost-state items, which is more flexible.

In at least one embodiment of the present disclosure, the lost-state items in the second game scene include resource identifiers for indicating a virtual character to which a virtual resource belongs. For example, please refer to FIG. 4, different virtual items include the resource identifiers of the virtual characters to which they belong, such as: player 1, player 2, player 3, etc. The above-mentioned game interaction method also includes the following step:
allocating a target virtual resource corresponding to the game action to an item inventory corresponding to the first virtual character, in response to the game action performed by the first virtual character in the second game scenario for the lost-state items with the resource identifier belonging to the first virtual character.

For example, player 1 can only retrieve the virtual resources with the resource identifier of player 1 through game actions in the second game scene, and cannot pick up other virtual resources with other resource identifiers such as player 2, player 3, etc., so as to prevent the virtual resources of the player from being captured by other players in the second game scene, reduce the difficulty of the game, and thus improve the game experience of the player.

In at least one embodiment of the present disclosure, the first terminal can display the virtual resources with resource identifiers corresponding to the virtual character controlled by the first terminal in the second game scene in a differentiated manner from the virtual resources with other resource identifiers, so that the player can quickly identify and retrieve them, thereby improving the efficiency of retrieving virtual resources.

Please refer to FIG. 5, in at least one embodiment of the present disclosure, after the above step 101 of configuring at least part of the virtual items as lost-state items, the above game interaction method also includes the following steps 501-502:
step 501, randomly configuring the lost-state items to different positions in the second game scene;
step 502, randomly displaying the lost-state items in the different positions.

That is, the lost-state items lost by the player appear randomly in different positions in the second game scene, and the time when the lost-state items appear in each position is also random and not fixed. In this way, the interaction richness of the player in the second game scene can be improved, thereby improving game experience of the player.

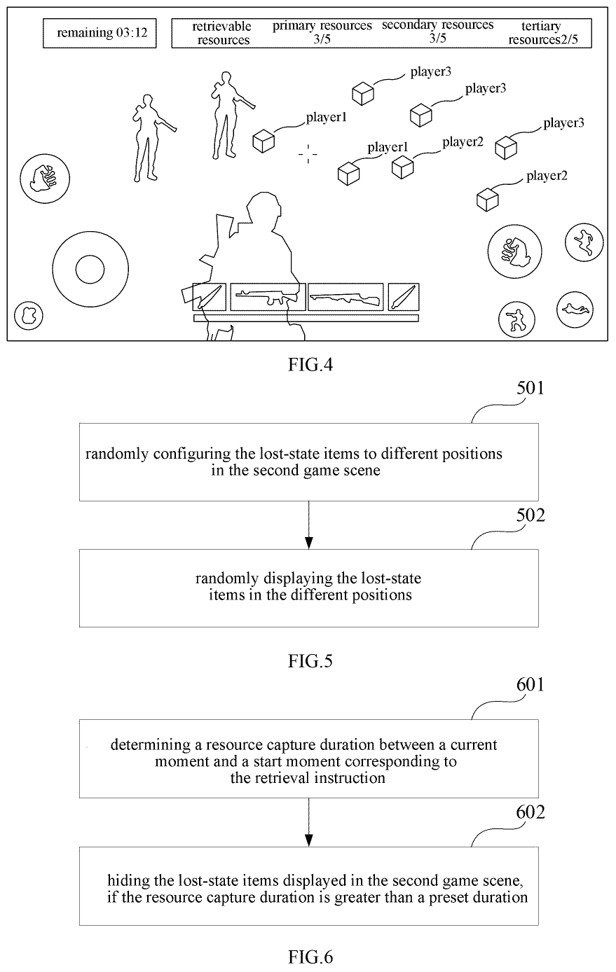

Please refer to FIG. 6, in at least one embodiment of the present disclosure, the game interaction method further includes the following steps 601-602.
Step 601, a resource capture duration between a current moment and a start moment corresponding to the retrieval instruction is determined.

The resource capture duration is the duration of item retrieval by the player in the second game scene.
Step 602, the lost-state items displayed in the second game scene is hidden, if the resource capture duration is greater than a preset duration.

The resource capture duration is the duration of the player in the second game scene. As the resource capture duration increases, the first terminal will gradually hide the lost-state items displayed in the second game scene, until all virtual resources completely disappear and cannot be retrieved. This interactive manner can enable players to retrieve virtual resources lost in the first game scene to a limited extent, improve the competitiveness of resource capture, and thus improve the richness of game interaction.

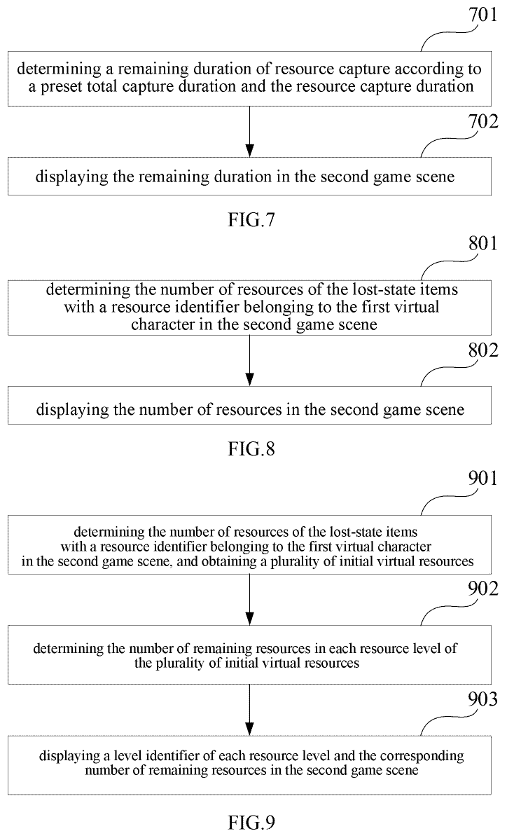

Please refer to FIG. 7, in at least one embodiment of the present disclosure, the game interaction method further includes the following steps 701-702.
Step 701, a remaining duration of resource capture is determined according to a preset total capture duration and the resource capture duration.

The resource capture duration is the duration of resource retrieval by the player in the second game scene. The preset total capture duration refers to the total capture duration set for resource retrieval in the second game scene. The remaining duration of resource capture can be obtained by calculating the difference between the preset total capture duration and the resource capture duration. For example, if the preset total capture duration is 5 minutes and the resource capture duration is 1 minute and 48 seconds, the corresponding remaining duration of resource capture is 3 minutes and 12 seconds.
Step 702, the remaining duration is displayed in the second game scene.

Please continue to refer to FIG. 4, in which the remaining duration of resource capture 03:12 is displayed.

The embodiment of the present disclosure determines the remaining duration of resource capture according to the preset total capture duration and resource capture duration, and displays the remaining duration in the graphical user interface in the second game scene, so as to facilitate the player to grasp the current resource capture duration in real time, so as to judge the resource capture strategy according to the actual situation, improve the efficiency of resource capture and game experience of the player.

Please refer to FIG. 8, in at least one embodiment of the present disclosure, the above game interaction method also includes the following steps 801-802:
step 801, determining the number of resources of the lost-state items with a resource identifier belonging to the first virtual character in the second game scene;
step 802, displaying the number of resources in the second game scene.

As the player retrieves resources in the second game scene through the resource capture operation, the number of virtual resources in the second game scene gradually decreases, and the first terminal counts or updates the types and numbers of virtual resources in the second game scene in real time, to obtain the number of resources of lost-state items of the first virtual character. The number of resources in the embodiment of the present disclosure is the number of virtual resources whose resource identifier is the current player remained in the second game scene after the player performs the resource capture operation.

The embodiment of the present disclosure determines the number of resources of the lost-state items with a resource identifier belonging to the first virtual character in the second game scene in real time, and displays the number of resources in the second game scene, so that the player can grasp the current resource capture progress in real time, determine the resource capture strategy according to the actual situation, improve the efficiency of resource capture, and improve game experience of the player.

In at least one embodiment of the present disclosure, the above lost-state items include a plurality of resource levels, for example, primary resources, secondary resources, tertiary resources, etc., and resources of different levels have different quantitative values or different qualities. For example, primary resources are high-quality resources, secondary resources are medium-quality resources, and tertiary resources are low-quality resources.

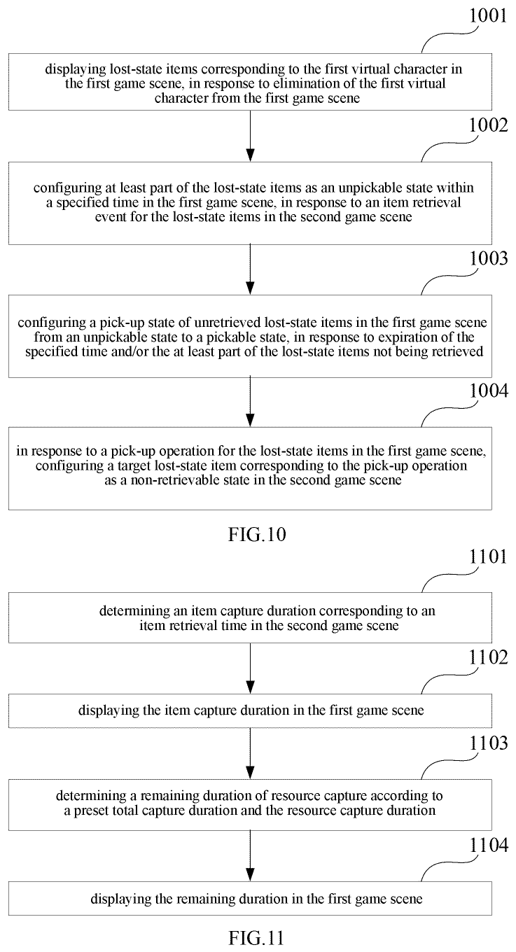

Please refer to FIG. 9, the above-mentioned step 801 of determining the number of resources of the lost-state items with a resource identifier belonging to the first virtual character in the second game scene includes following steps 901-903.
Step 901, the number of resources of the lost-state items with a resource identifier belonging to the first virtual character in the second game scene is determined, to obtain a plurality of initial virtual resources.

Please refer to FIG. 4, the initial virtual resource is the number of resources of lost-state items with a resource identifier belonging to the first virtual character controlled by the first terminal, for example, the first virtual character in the embodiments of this disclosure. For example, the number of initial virtual resources is 15.
Step 902, the number of remaining resources in each resource level of the plurality of initial virtual resources is determined.

Correspondingly, each virtual resource also includes a corresponding resource level, such as primary resources, secondary resources, tertiary resources, etc. According to the level identifier of the virtual resource, real-time statistics can be performed to determine the number of virtual resources in each resource level, and the number of remaining resources can be obtained.
Step 903, a level identifier of each resource level and the corresponding number of remaining resources are displayed in the second game scene.

Please continue to refer to FIG. 4, for example, the total number of primary resources is 5, the number of remaining resources is 3, the total number of secondary resources is 5, the number of remaining resources is 3, the total number of tertiary resources is 5, and the number of remaining resources is 2.

The embodiment of the present disclosure determines the number of remaining resources in each resource level of the plurality of initial virtual resources in real time, and displays a level identifier of each resource level and the corresponding number of remaining resources in the second game scene, so as to facilitate players to grasp the capture progress of virtual resources of each level in real time, so as to judge the resource capture strategy according to the actual situation, improve the efficiency of resource capture, and improve the game experience of players.

In at least one embodiment of the present disclosure, the game interaction method further includes:
configuring a target lost-state item corresponding to a pick-up operation as a non-retrievable state in the second game scene, in response to the pick-up operation for the lost-state item in the first game scene within a specified time.

For example, the first player controls the first virtual character in the first terminal to pick up the lost-state items lost by the first virtual character in the first game scene in the second game scene, and at the same time, the second player controls the second virtual character in the second terminal to pick up the lost-state items lost by the first virtual character in the first game scene, that is, the lost-state items lost by the first virtual character appear in the first game scene and the second game scene at the same time, and the first virtual character and the second virtual character pick them up at the same time, thereby forming a competitive state.

For the picking operation of lost-state items in the first game scene within the specified time, the target lost-state items corresponding to the pick-up operation are configured as non-retrievable in the second game scene, that is, some items picked up by other virtual characters in the first game scene will be displayed as non-retrievable in the second game scene, and the first virtual character cannot pick them up. In this way, the competitiveness and diversity of game interaction can be improved.

Please refer to FIG. 10, an embodiment of the present disclosure provides a game interaction method, which is applied to a second terminal. As in the above embodiment, a graphical user interface is provided by the second terminal. The content displayed by the graphical user interface includes a first game scene, and the first game scene includes a first virtual character carrying virtual items and a second virtual character controlled by the second terminal. The above game interaction method includes the following steps 1001-1004.
Step 1001, lost-state items corresponding to the first virtual character are displayed in the first game scene, in response to elimination of the first virtual character from the first game scene.

The lost-state items are at least part of the virtual items. When the second terminal responds to the elimination of the first virtual character in the first game scene, part of the items carried by the first virtual character will not be taken out of the game by the first virtual character, but will be configured as lost-state items, and the lost-state items will be displayed in the first game scene. In the first game scene, other virtual characters other than the first virtual character have not been eliminated, such as the second virtual character, and the second virtual character can pick up the lost-state items in the first game scene.
Step 1002, at least part of the lost-state items is configured as an unpickable state within a specified time in the first game scene, in response to an item retrieval event for the lost-state items in the second game scene.

The lost-state items appear in the first game scene and the second game scene at the same time. The first virtual character retrieves the resources in the second game scene, and the second virtual character picks up the items in the first game scene, that is, executes the item retrieval event. Once the first virtual character completes the set game action in the second game scene, the lost-state resources corresponding to the game action can be configured as an unpickable state in the first game scene, that is, the second virtual character cannot pick up the lost-state items in the unpickable state in the first game scene.
Step 1003, a pick-up state of unretrieved lost-state items in the first game scene is configured from an unpickable state to a pickable state, in response to expiration of the specified time and/or the at least part of the lost-state items not being retrieved.
Step 1004, in response to a pick-up operation for the lost-state items in the first game scene, a target lost-state item corresponding to the pick-up operation is configured as a non-retrievable state in the second game scene.

The pick-up state of unretrieved lost-state items in the first game scene is configured from an unpickable state to a pickable state. That is, within the specified time, the first virtual character can retrieve the resources in the second game scene by completing the set game action. Once the specified time is exceeded, the items that have not been retrieved will be in the non-retrievable state in the second game scene, and converted to the pickable state in the first game scene, so that the second virtual character can continue to pick them up in the first game scene.

By setting a specified time for limiting the first virtual character to retrieve items in the second game scene, the efficiency of the first virtual character in retrieving items can be promoted to a certain extent, and at the same time, the item picking rights of the second virtual character as the winner are guaranteed, thereby improving the competitiveness of the game and the richness of game interaction.

Please refer to FIG. 11, in at least one embodiment of the present disclosure, the above game interaction method also includes the following steps 1101-1104:
step 1101, determining a resource capture duration corresponding to an item retrieval time in the second game scene;
step 1102, displaying the resource capture duration in the first game scene;
step 1103, determining a remaining duration of resource capture according to a preset total capture duration and the resource capture duration;
step 1104, displaying the remaining duration in the first game scene.

That is, while the first virtual character retrieves items in the second game scene, at least one of the current resource capture duration and remaining duration of the first virtual character can be displayed in the first game scene, so that the second virtual character can intuitively understand the current item retrieval state of the first virtual character in the first game scene, which is more intuitive; and at the same time, the efficiency of the second virtual character in picking up items in the first game scene can be improved to a certain extent.

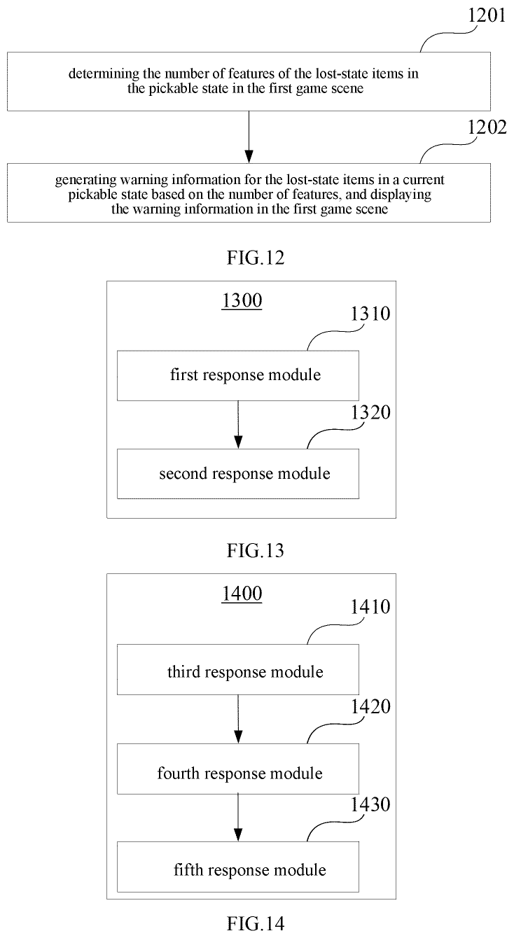

Please refer to FIG. 12, in at least one embodiment of the present disclosure, the above game interaction method also includes the following steps 1201-1202:
step 1201, determining the number of features of the lost-state items in the pickable state in the first game scene;
step 1202, generating warning information for the lost-state items in a current pickable state based on the number of features, and displaying the warning information in the first game scene.

The warning information can be directly the number of features, or it can be a color warning generated based on the number of features, for example, when the number of features is less than the first value, a warning icon of the first color is displayed, when the number of features is between the first value and the second value, a warning icon of the second color is displayed, when the number of features is between the second value and the third value, a warning icon of the third color is displayed, and so on. The form of the warning information includes but is not limited to the above two types, which can be specifically selected or set according to actual conditions.

The embodiment of the present disclosure generates warning information based on the number of features of virtual items that can be picked up by the second virtual character in the first game scene, so that the second virtual character can intuitively determine the current state of the pickable resources in the first game scene, which is more intuitive and can promote the efficiency of the second virtual character in picking up resources to a certain extent.

Please refer to FIG. 13, in order to realize the above-mentioned game interaction method, a game interaction apparatus 1300 is provided in an embodiment of the present disclosure, and FIG. 13 shows a schematic architecture diagram of the game interaction apparatus 1300. A graphical user interface is provided through a first terminal, a content displayed by the graphical user interface includes a first game scene, the first game scene includes a first virtual character controlled by the first terminal, the first virtual character carries virtual items, and the first game scene is a current in-game scene of the first virtual character. The game interaction apparatus 1300 includes: a first response module 1310 and a second response module 1320.

The first response module 1310 is configured to control to configure at least part of the virtual items as lost-state items, in response to elimination of the first virtual character in the first game scene.

The second response module 1320 is configured to load a second game scene in the graphical user interface in response to a retrieval instruction for the lost-state items, and configure the lost-state items into the second game scene, such that the first virtual character corresponding to the first terminal is able to retrieve the lost-state items by completing a specified game action in the second game scene, wherein the second game scene is a current out-of-game scene of the first virtual character.

In at least one embodiment of the present disclosure, the virtual items include a plurality of security levels, the first response module 1310 is specifically used to: control to configure items in the virtual items with a security level less than a preset security level as lost-state items, in response to the elimination of the first virtual character in the first game scene.

In at least one embodiment of the present disclosure, the second response module 1320 is specifically used to: display an item capture control in the graphical user interface; load the second game scene in the graphical user interface, in response to a confirmation operation for the item capture control, wherein an instruction corresponding to the confirmation operation is the retrieval instruction for the lost-state items.

In at least one embodiment of the present disclosure, the second response module 1320 is also used to: control the first virtual character to exit the first game scene, and control to reclaim the virtual items carried by the first virtual character in the first game scene, in response to an abandonment operation for the item capture control.

In at least one embodiment of the present disclosure, the lost-state items in the second game scene include resource identifiers for indicating a virtual character to which a virtual resource belongs; the second response module 1320 is also used to: allocate a target virtual resource corresponding to the game action to an item inventory corresponding to the first virtual character, in response to the game action performed by the first virtual character in the second game scenario for the lost-state items with the resource identifier belonging to the first virtual character.

In at least one embodiment of the present disclosure, the first response module 1310 is also used to: randomly configure the lost-state items to different positions in the second game scene; randomly display the lost-state items in the different positions.

In at least one embodiment of the present disclosure, the second response module 1320 is also used to: determine a resource capture duration between a current moment and a start moment corresponding to the retrieval instruction; hide the lost-state items displayed in the second game scene, if the resource capture duration is greater than a preset duration.

In at least one embodiment of the present disclosure, the second response module 1320 is also used to: determine a remaining duration of resource capture according to a preset total capture duration and the resource capture duration; display the remaining duration in the second game scene.

In at least one embodiment of the present disclosure, the second response module 1320 is also used to: determine the number of resources of the lost-state items of the first virtual character in the second game scene with a resource identifier; and display the number of resources in the second game scene.

In at least one embodiment of the present disclosure, the lost-state items include a plurality of resource levels; the second response module 1320 is specifically used to: determine the number of resources of the lost-state items with a resource identifier belonging to the first virtual character in the second game scene, to obtain a plurality of initial virtual resources; determine the number of remaining resources in each resource level of the plurality of initial virtual resources; display a level identifier of each resource level and the corresponding number of remaining resources in the second game scene.

In at least one embodiment of the present disclosure, the second response module 1320 is also used to: configure a target lost-state item corresponding to a pick-up operation as a non-retrievable state in the second game scene, in response to the pick-up operation for the lost-state item in the first game scene within a specified time.

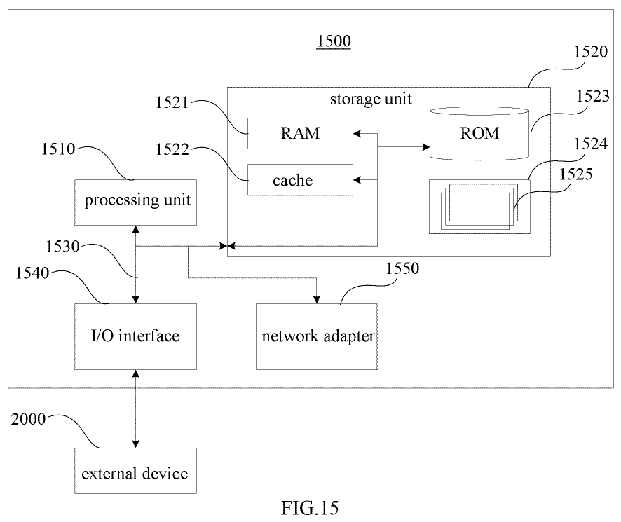

Please refer to FIG. 14, in order to implement the above-mentioned game interaction method, a game interaction apparatus 1400 is provided in one embodiment of the present disclosure. FIG. 14 shows a schematic architecture diagram of the game interaction apparatus 1400. A graphical user interface is provided through a second terminal, a content displayed by the graphical user interface includes a first game scene, the first game scene includes a first virtual character carrying virtual items and a second virtual character controlled by the second terminal, wherein the game interaction apparatus 1400 includes: a third response module 1410, a fourth response module 1420, and a fifth response module 1430.

The third response module 1410 is configured to display lost-state items corresponding to the first virtual character in the first game scene, in response to elimination of the first virtual character from the first game scene, wherein the lost-state items are at least part of the virtual items.

The fourth response module 1420 is configured to configure at least part of the lost-state items as an unpickable state within a specified time in the first game scene, in response to an item retrieval event for the lost-state items in the second game scene.

The fifth response module 1430 is configured to configure a pick-up state of unretrieved lost-state items in the first game scene from the unpickable state to a pickable state, in response to expiration of the specified time and/or the at least part of the lost-state items not being retrieved.

In at least one embodiment of the present disclosure, the fourth response module 1420 is also used to: in response to a pick-up operation for the lost-state items in the first game scene, configure a target lost-state item corresponding to the pick-up operation as a non-retrievable state in the second game scene.

In at least one embodiment of the present disclosure, the third response module 1410 is also used to: determine a resource capture duration corresponding to an item retrieval time in the second game scene; display the resource capture duration in the first game scene; and/or, determine a remaining duration of resource capture according to a preset total capture duration and the resource capture duration; display the remaining duration in the first game scene.

In at least one embodiment of the present disclosure, the fifth response module 1430 is also used to: determine the number of features of the lost-state items in the pickable state in the first game scene; generate warning information for the lost-state items in a current pickable state based on the number of features, and display the warning information in the first game scene.

The example embodiment of the present disclosure also provides a non-transitory computer-readable storage medium, which can be implemented in the form of a program product, which includes a program code, and when the program product is run on an electronic device, the program code is used to enable the electronic device to perform the steps according to various example embodiments of the present disclosure described in the above “Exemplary Method” section of this specification. In one embodiment, the program product can be implemented as a portable compact disk read-only memory (CD-ROM) and includes a program code, and can be run on an electronic device, such as a personal computer. However, the program product of the present disclosure is not limited thereto. In this specification, a readable storage medium may be any tangible medium containing or storing a program that can be used by or in conjunction with an instruction execution system, apparatus, or device.

The program product may employ any combination of one or more readable media. The readable medium may be a readable signal medium or a readable storage medium. The readable storage medium may be, for example, but not limited to, an electrical, magnetic, optical, electromagnetic, infrared, or semiconductor system, apparatus, or device, or any combination thereof. More specific examples of readable storage media (a non-exhaustive list) include: an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

A computer readable signal medium may include a data signal propagated in baseband or as part of a carrier wave, carrying a readable program code. Such a propagated data signal may take a variety of forms, including but not limited to an electromagnetic signal, an optical signal, or any suitable combination thereof. The readable signal medium may also be any readable medium other than a readable storage medium that can send, propagate or transmit a program for use by or in conjunction with an instruction execution system, apparatus or device.

The program code contained on the readable medium may be transmitted using any appropriate medium, including but not limited to wireless, wired, optical cable, RF, etc., or any suitable combination of the foregoing.

The program code for performing the operations of the present disclosure may be written in any combination of one or more programming languages, including object-oriented programming languages, such as Java, C++, etc., and conventional procedural programming languages, such as “C” language or similar programming languages. The program code may be executed entirely on the user computing device, partially on the user device, executed as a separate software package, partially on the user computing device and partially on a remote computing device, or entirely on a remote computing device or server. In the case of a remote computing device, the remote computing device may be connected to the user computing device via any type of network, including a local area network (LAN) or a wide area network (WAN), or may be connected to an external computing device (e.g., via the Internet using an Internet service provider). In the embodiment of the present disclosure, when the program code stored in the computer-readable storage medium is executed, any step in the above game interaction method can be implemented.

Referring to FIG. 15, the example embodiment of the present disclosure also provides an electronic device 1500, which can be a background server of an information platform. The electronic device 1500 is described below with reference to FIG. 15. It should be understood that the electronic device 1500 shown in FIG. 15 is only an example and should not impose any restrictions on the functions and scope of use of the embodiment of the present disclosure.

As shown in FIG. 15, the electronic device 1500 is presented in the form of a general computing device. The components of the electronic device 1500 may include, but are not limited to: at least one processing unit 1510, at least one storage unit 1520, and a bus 1530 connecting different system components (including the storage unit 1520 and the processing unit 1510).

The storage unit stores the program code, and the program code can be executed by the processing unit 1510, such that the processing unit 1510 performs the steps according to various example embodiments of the present disclosure described in the above “Exemplary Method” section of this specification. For example, the processing unit 1510 can perform steps of the method shown in FIG. 1, etc.

The storage unit 1520 may include a transitory storage unit, such as a random access storage unit (RAM) 1521 and/or a cache storage unit 1522, and may further include a read-only storage unit (ROM) 1523.

The storage unit 1520 may also include a program/utility 1524 having a set (at least one) of program modules 1525, such program modules 1525 including but not limited to: an operating system, one or more application programs, other program modules, and program data, each of which or a combination thereof may include the implementation of a network environment.

The bus 1530 may include a data bus, an address bus, and a control bus.

The electronic device 1500 may also communicate with one or more external devices 2000 (such as a keyboard, a pointing device, a Bluetooth device, etc.), and such communication may be performed through an input/output (I/O) interface 1540. The electronic device 1500 may also communicate with one or more networks (such as a local area network (LAN), a wide area network (WAN), and/or a public network, such as the Internet) through a network adapter 1550. As shown in the drawings, the network adapter 1550 communicates with other modules of the electronic device 1500 via the bus 1530. It should be understood that, although not shown in the drawings, other hardware and/or software modules can be used in conjunction with the electronic device 1500, including but not limited to: microcode, device drivers, redundant processing units, external disk drive arrays, RAID systems, tape drives, and data backup storage systems, etc.

In the embodiment of the present disclosure, when the program code stored in the electronic device is executed, any step in the above game interaction methods can be implemented.

It should be noted that although several modules or units of the device for action execution are mentioned in the above detailed description, such division is not mandatory. In fact, according to the example embodiment of the present disclosure, the features and functions of two or more modules or units described above can be embodied in one module or unit. Conversely, the features and functions of one module or unit described above can be further divided into multiple modules or units to be embodied.

Those skilled in the art can understand that various aspects of the present disclosure can be implemented as a system, method or program product. Therefore, various aspects of the present disclosure may be specifically implemented in the following forms, namely: a complete hardware implementation, a complete software implementation (including firmware, microcode, etc.), or an implementation combining hardware and software aspects, which may be collectively referred to herein as a “circuit”, “module” or “system”. Those skilled in the art will easily think of other implementations of the present disclosure after considering the specification and practicing the disclosure disclosed herein. The present disclosure is intended to cover any variation, use or adaptation of the present disclosure, which follows the general principles of the present disclosure and includes common knowledge or customary technical means in the art that are not disclosed in the present disclosure. The description and implementation are to be regarded as exemplary only, and the true scope and spirit of the present disclosure are indicated by the claims.

It should be understood that the present disclosure is not limited to the precise structure described above and shown in the drawings, and various modifications and changes may be made without departing from its scope. The scope of the present disclosure is limited only by the appended claims.

1. A game interaction method, comprising:
providing a graphical user interface through a first terminal, wherein a content displayed by the graphical user interface comprises a first game scene, the first game scene comprises a first virtual character controlled by the first terminal, the first virtual character carries virtual items, and the first game scene is a current in-game scene of the first virtual character;
controlling to configure at least part of the virtual items as lost-state items, in response to elimination of the first virtual character in the first game scene; and
loading a second game scene in the graphical user interface in response to a retrieval instruction for the lost-state items, and configuring the lost-state items into the second game scene, such that the first virtual character corresponding to the first terminal is able to retrieve the lost-state items by completing a specified game action in the second game scene, wherein the second game scene is a current out-of-game scene of the first virtual character.

2. The game interaction method according to claim 1, wherein the virtual items comprise a plurality of security levels, and controlling to configure at least part of the virtual items as lost-state items in response to elimination of the first virtual character in the first game scene comprises:
controlling to configure items in the virtual items with a security level less than a preset security level as lost-state items, in response to the elimination of the first virtual character in the first game scene.

3. The game interaction method according to claim 1, wherein loading a second game scene in the graphical user interface in response to a retrieval instruction for the lost-state items comprises:
displaying an item capture control in the graphical user interface;
loading the second game scene in the graphical user interface, in response to a confirmation operation for the item capture control, wherein an instruction corresponding to the confirmation operation is the retrieval instruction for the lost-state items.

4. The game interaction method according to claim 3, further comprising:
controlling the first virtual character to exit the first game scene, and controlling to reclaim the virtual items carried by the first virtual character in the first game scene, in response to an abandonment operation for the item capture control.

5. The game interaction method according to claim 1, wherein the lost-state items in the second game scene comprise resource identifiers for indicating a virtual character to which a virtual resource belongs; the method further comprises:
allocating a target virtual resource corresponding to the game action to an item inventory corresponding to the first virtual character, in response to the game action performed by the first virtual character in the second game scenario for the lost-state items with the resource identifier belonging to the first virtual character.

6. The game interaction method according to claim 1, further comprising:
randomly configuring the lost-state items to different positions in the second game scene;
randomly displaying the lost-state items in the different positions.

7. The game interaction method according to claim 1, further comprising:
determining a resource capture duration between a current moment and a start moment corresponding to the retrieval instruction;
hiding the lost-state items displayed in the second game scene, in response that the resource capture duration is greater than a preset duration.

8. The game interaction method according to claim 7, further comprising:
determining a remaining duration of resource capture according to a preset total capture duration and the resource capture duration;
displaying the remaining duration in the second game scene.

9. The game interaction method according to claim 1, further comprising:
determining the number of resources of the lost-state items with a resource identifier belonging to the first virtual character in the second game scene;
displaying the number of resources in the second game scene.

10. The game interaction method according to claim 9, wherein the lost-state items comprise a plurality of resource levels; determining the number of resources of the lost-state items with a resource identifier belonging to the first virtual character in the second game scene comprises:
determining the number of resources of the lost-state items with a resource identifier belonging to the first virtual character in the second game scene, and obtaining a plurality of initial virtual resources;
determining the number of remaining resources in each resource level of the plurality of initial virtual resources;
displaying a level identifier of each resource level and the corresponding number of remaining resources in the second game scene.

11. The game interaction method according to claim 1, further comprising:
configuring a target lost-state item corresponding to a pick-up operation as a non-retrievable state in the second game scene, in response to the pick-up operation for the lost-state item in the first game scene within a specified time.

12. A game interaction method, comprising:
providing a graphical user interface through a second terminal, wherein a content displayed by the graphical user interface comprises a first game scene, the first game scene comprises a first virtual character carrying virtual items and a second virtual character controlled by the second terminal;
displaying lost-state items corresponding to the first virtual character in the first game scene, in response to elimination of the first virtual character from the first game scene, wherein the lost-state items are at least part of the virtual items;
configuring at least part of the lost-state items as an unpickable state within a specified time in the first game scene, in response to an item retrieval event for the lost-state items in the second game scene; and
configuring a pick-up state of unretrieved lost-state items in the first game scene from an unpickable state to a pickable state, in response to at least one of expiration of the specified time or the at least part of the lost-state items not being retrieved.

13. The game interaction method according to claim 12, further comprising:
configuring, in response to a pick-up operation for the lost-state items in the first game scene, a target lost-state item corresponding to the pick-up operation as a non-retrievable state in the second game scene.

14. The game interaction method according to claim 12, further comprising:
determining a resource capture duration corresponding to an item retrieval time in the second game scene;
displaying the resource capture duration in the first game scene;
determining a remaining duration of resource capture according to a preset total capture duration and the resource capture duration;
displaying the remaining duration in the first game scene.

15. The game interaction method according to claim 12, further comprising:
determining the number of features of the lost-state items in the pickable state in the first game scene;
generating warning information for the lost-state items in a current pickable state based on the number of features, and displaying the warning information in the first game scene.

16-17. (canceled)

18. A non-transitory computer-readable storage medium, having a computer program stored thereon, wherein the computer program implements the method of claim 1 when executed by a processor.

19. An electronic device, comprising:
a processor; and
a memory for storing executable instructions of the processor;
wherein executable instructions are executed by the processor, the processor is configured to:
provide a graphical user interface, wherein a content displayed by the graphical user interface comprises a first game scene, the first game scene comprises a first virtual character controlled by the electronic device, the first virtual character carries virtual items, and the first game scene is a current in-game scene of the first virtual character;
control to configure at least part of the virtual items as lost-state items, in response to elimination of the first virtual character in the first game scene; and
load a second game scene in the graphical user interface in response to a retrieval instruction for the lost-state items, and configuring the lost-state items into the second game scene, such that the first virtual character corresponding to the electronic device is able to retrieve the lost-state items by completing a specified game action in the second game scene, wherein the second game scene is a current out-of-game scene of the first virtual character.

20. An electronic device, comprising:
a processor; and
a memory for storing executable instructions of the processor;
wherein the processor is configured to execute the game interaction method according to claim 12 by executing the executable instructions.

21. A non-transitory computer-readable storage medium, having a computer program stored thereon, wherein the computer program implements the game interaction method according to claim 12 when executed by a processor.

22. The game interaction method according to claim 5, wherein the first terminal displays the virtual resource with the resource identifier belonging to the first virtual character in the second game scene in a differentiated manner from virtual resources with other resource identifiers.
